(19) United States
(12) Patent Application Publication
(10) Pub. No.: US 2008/0256452 A1
(43) Pub. Date: Oct. 16, 2008

(54) CONTROL OF AN OBJECT IN A VIRTUAL REPRESENTATION BY AN AUDIO-ONLY DEVICE

(76) Inventor: Philipp Christian Berndt, Berlin (DE)

Correspondence Address: HUGH P. GORTLER, 23 ARRIVO DRIVE, MISSION VIEJO, CA, 92692, US

(21) Appl. No.: 11/774,556

(22) Filed: Jul. 6, 2007

Related U.S. Application Data
(63) Continuation-in-part of application No. 11/735,463, filed on Apr. 14, 2007.
Application No. 11/735,463 is a continuation-in-part of application No. 11/751,152, filed on May 21, 2007.

(51) Int. Cl. G06F 3/16

(52) U.S. Cl. 715/728

(57) ABSTRACT

Control of objects in a virtual representation includes receiving signals from audio-only devices, and controlling states of the objects in response to the signals.

### BRIEF DESCRIPTION OF THE DRAWINGS

FIG. 1 is an illustration of a system in accordance with an embodiment of the present invention.

FIG. 2 is an illustration of a method in accordance with an embodiment of the present invention.

FIG. 3 is an illustration of a virtual environment in accordance with an embodiment of the present invention.

FIG. 4 is an illustration of a system in accordance with an embodiment of the present invention.

FIGS. 5-6 are illustrations of a method of mixing sound in accordance with an embodiment of the present invention.

### DETAILED DESCRIPTION

For the purpose of illustration, the present invention is embodied in the control of an object in a virtual environment or other virtual representation. The object can be controlled without seeing the virtual representation.

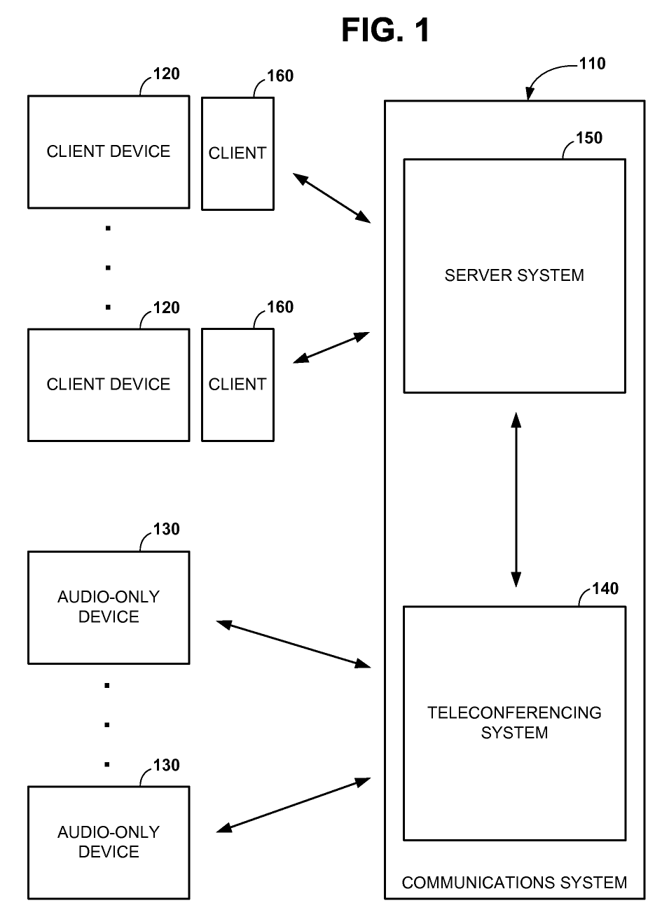

Reference is made to FIG. 1, which illustrates a communications system 110 for providing a communications service. The service may be provided to users having client devices 120 and audio-only devices 130. A client device 120 refers to a device that can run a client and provide a graphical interface. One example of a client is a Flash® client. Client devices 120 are not limited to any particular type. Examples of client devices 120 include, but are not limited to computers, tablet PCs, VOIP phones, gaming consoles, televisions with set-top boxes, certain cell phones, and personal digital assistants. Another example of a client device 120 is a device running a Telnet program.

Audio-only devices 130 refer to devices that provide audio but, for whatever reason, do not display a virtual representation (a virtual representation is described below). Examples of audio-only devices 130 include traditional phones (e.g., touch-tone phones) and VOIP phones.

The communications system 110 includes a teleconferencing system 140 for hosting teleconferences. The teleconferencing system 140 may include a phone system for establishing phone connections with traditional phones (landline and cellular), VOIP phones, and other audio-only devices 130. For example, a user of a traditional phone can connect with the teleconferencing system 140 by placing a call to it. The teleconferencing system 140 may also include means for establishing connections with client devices 120 that have teleconferencing capability (e.g., a computer equipped with a microphone, speakers and teleconferencing software).

A teleconference is not limited to conversations between two users. A teleconference can involve many users. Moreover, the teleconferencing system 140 can host one or more teleconferences at any given time.

The communications system 110 further includes a server system 150 for providing clients 160 to those users having client devices 120. Each client 160 causes its client device 120 to display a virtual representation. A virtual representation provides a vehicle by which a user can enter into a teleconference (e.g., initiate a teleconference, join a teleconference already in progress), even if that user knows no other users represented in the virtual representation. The communications system 110 allows a user to listen in on one or more teleconferences. Even while engaged in one teleconference, a user has the ability to listen in on other teleconferences, and seamlessly leave the one teleconference and join another teleconference. A user could even be involved in a chain of teleconferences (e.g., a line of people where person C hears B and D, and person D hears C and E, and so on).

A virtual representation is not limited to any particular number of dimensions. A virtual representation could be depicted in two dimensions, three dimensions, or higher.

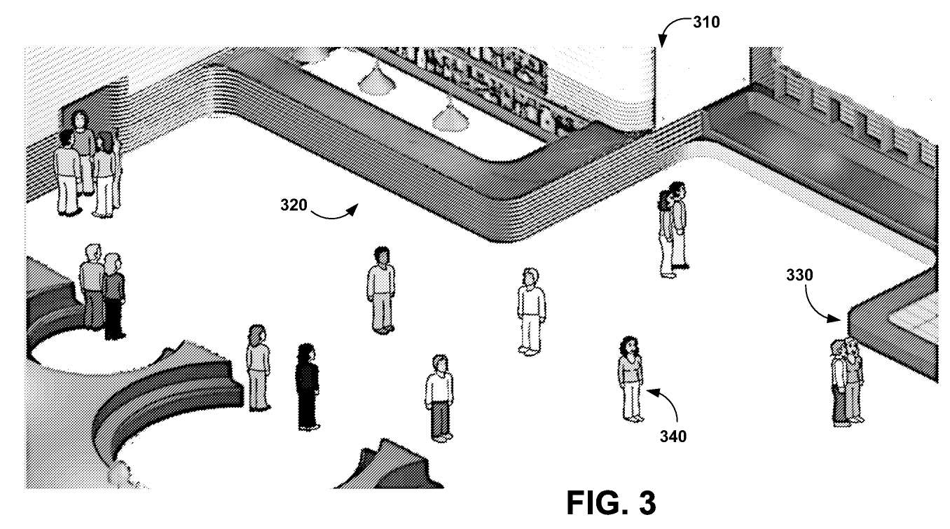

A virtual representation is not limited to any particular type. A first type of virtual representation could be similar to the visual metaphorical representations illustrated in FIGS. 3-5 and 8a-8b of Singer et al. U.S. Pat. No. 5,889,843 (a graphical user interface displays icons on a planar surface, where the icons represent audio sources).

A second type of virtual representation is a virtual environment. A virtual environment includes a scene and (optionally) sounds. A virtual environment is not limited to any particular type of scene or sounds. As a first example, a virtual environment includes a beach scene with blue water, white sand and blue sky. In addition, the virtual environment includes an audio representation of a beach (e.g. waves crashing against the shore, sea gulls cries). As a second example, a virtual environment includes a club scene, complete with bar, dance floor, and dance music (an exemplary bar scene 310 is depicted in FIG. 3).

A virtual representation includes objects. An object in a virtual environment has properties that allow a user to perform certain actions on them (e.g. sit on, move, and open). An object (e.g. a Flash® object) in a virtual environment may obey certain specifications (e.g. an API).

At least some of the objects represent users of the communications system 110. These user objects could be images, avatars, live video, recorded sound samples, name tags, logos, user profiles, etc. In the case of avatars, live video or photos could be projected on them. The user objects allow their users to see and communicate with other users in a virtual representation. In some situations, the user cannot see his own representative object, but rather sees the virtual representation as his representative object would see it (that is, from a first person perspective).

Each client 160 enables its client device 120 to move the user's representative object within the virtual representation. By moving his representative object around a virtual representation, a user can listen in on teleconferences, and approach and meet different users. By moving his representative object around a virtual environment, a user can experience the sights and sounds that the virtual environment offers.

In a virtual environment, objects representing users may have states that change. For instance, an avatar has states such as location and orientation. The avatar can walk (that is, make a gradual transition) from its current location (current state) to a new location (new state).

Other objects (that don't represent users) in a virtual environment might have states that transition gradually or abruptly. A user can also change the states of these other objects. As a first example, a user can take part in a virtual volleyball game, where a volleyball is represented by an object. Hitting the volleyball causes the volleyball to follow a path towards a new location. As a second example, a balloon is represented by an object. The balloon may start uninflated (e.g., a current state) and expand gradually to a fully inflated size (e.g., a new state). As a third example, an object represents a jukebox having methods (actions) such as play/stop/pause, and properties such as volume, song list, and song selection. As a fourth example, an object represents an Internet object, such as a uniform resource identifier (URI) (e.g., a web address). Clicking on the object opens an Internet connection.

Additional reference is made to FIG. 3, which depicts an exemplary virtual environment including a club scene 310. The club scene 310 includes a bar 320, and dance floor 330. A user is represented by an avatar 340. Other users in the club scene 310 are represented by other avatars. Dance music is projected from speakers (not shown) near the dance floor 330. As the user's avatar 340 approaches the speakers, the music heard by the user becomes louder. The music is loudest when the user's avatar 340 is in front of the speakers. As the user's avatar 340 is moved away from the speakers, the music becomes softer. If the user's avatar 340 is moved to the bar 320, the user hears background conversation (which might be actual conversations between other users at the bar 320). The user might hear other background sounds at the bar 320, such as a bartender washing glasses or mixing drinks. An object's audio characteristics might be changed by applying filters (e.g. reverb, club acoustics) to the object's sound data. An avatar could be moved from its current location to a new location by clicking on the new location in the virtual environment, pressing a key on a keyboard, entering text, entering a voice command, etc.

The user might not know any of the other users represented in the club scene 310. However, the user can cause his avatar 340 to approach another avatar to enter into a teleconference with that other avatar's user (the users can start speaking with each other as soon as both avatars are within audio range of each other). Users can use their audio-only devices 130 to speak with each other (each audio-only device 130 makes a connection with the teleconferencing system 140, and the teleconferencing system 140 completes the connection between the audio-only devices 130). The user can command his avatar 340 to leave that teleconference, wander around the club scene 310, and approach other avatars so as to listen in on other conversations and teleconference with other people.

The communications system 110 can host multiple virtual representations simultaneously. The communications system 110 can host multiple teleconferences in each virtual representation. Each teleconference can include two or more people.

If more than one virtual representation is available to a user, the user can move in and out of the different virtual representations. Each of the virtual representations can be uniquely addressable via a unique phone number. The server system 150 can then place each user directly into the selected virtual representation.

Users can reserve and enter private virtual representations to hold private conversations. Users can also reserve and enter private areas of virtual representations to hold private conversations.

This interaction is unlike that of a conventional teleconference. In a conventional teleconference, several parties call a number and talk. When they're finished talking, they hang up. In contrast, a virtual representation according to the present invention is dynamic. Multiple teleconferences might be occurring between different groups of people. A user can listen in on one or more teleconferences simultaneously, enter into and leave a teleconference at will, and hop from one teleconference to another. The teleconferencing is dynamic.

A user can utilize both a client device 120 and an audio-only device 130 during a teleconference. The client device 120 is used to interact with the virtual representation and find others to speak with. The audio-only device 130 is used to speak with others.

However, some users might only have access to audio-only devices. Yet, such users can still control objects in a virtual representation. For example, such users can move their representative objects around a virtual representation to listen in on teleconferences, and approach and speak with other users. By moving their representative objects around a virtual environment, a user having only an audio-only device can hear the sounds, but not see the sights, that a virtual environment offers.

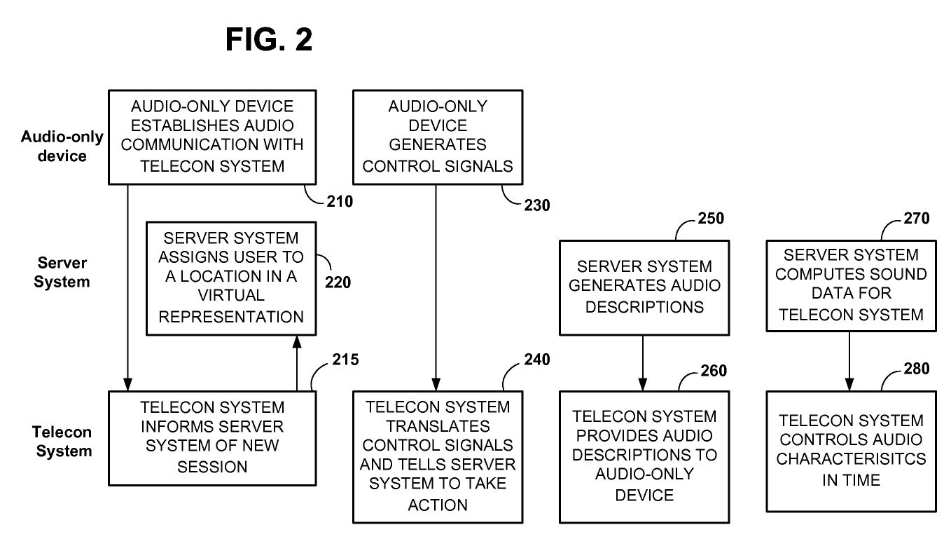

Reference is now made to FIG. 2. To start a session with only an audio-only device, an audio-only device establishes audio communications with the teleconferencing system (block 210). With a traditional telephone, the user can call a virtual representation (e.g., by calling a unique phone number, or by calling a general number and entering additional data such as a user ID and PIN, via DTMF). With a VOIP phone, a user could for instance call a virtual representation by calling its unique VOIP address.

The teleconferencing system informs the server system of the session (block 215). The server system assigns the user to a location within a virtual representation (block 220).

The audio-only device generates signals for selecting and controlling objects in the virtual representation (block 230). The signals are not limited to any particular type. As examples, the signals may be dial tone (DTMF) signals, voice signals, or some other type of phone signal.

Consider a touch tone phone. Certain buttons on the phone can correspond to commands. A user with a touch phone or DTMF-enabled VOIP phone can execute a command by entering that command using DTMF tones. Each command can be supplied with one or more arguments. An argument could be a phone number or other number sequence. In some embodiments, voice commands could be interpreted and used.

A command argument might expect a value from a list of options. The options may be structured in a tree so that the user selects a first group with one digit and is then presented the resulting subsets of remaining options and so on. The most probable options could be listed first.

For example a user could press ‘0’ to enter a command menu where all available commands are read to the user. The user can then enter a CALL command (e.g., 2255) followed by the # sign. The user may then be asked to identify the person to call, e.g., by saying that person's name, entering that person's phone number, entering a code corresponding to that person, etc. Instead of pressing a button to enter the command menu the user could speak a catchword, such as “Computer.” The teleconferencing system could also detect, process and act upon audio signals before a user enters a command menu. For example the teleconferencing system could analyze the user's voice and detect a mood change and communicate it to the server system. The server system, in response, might modify the user's representative object to reflect that mood change.

Another command could cause an object to move within its virtual environment. Arguments of that command could specify direction, distance, new location, etc.

Another command could allow a user to switch to another virtual environment, and an argument of that command could specify the virtual environment. Another command could allow a user to join a teleconference. Another command could allow a user to request information about the environment or about other users. Another command could allow one user's avatar to take another user's avatar by the hand, whereby the latter avatar would follow (be piggybacked to) the former avatar.

Another command could allow a user to select an object representing an Internet resource, such as a web page. Arguments could specify certain links, URLs or bookmarks. For example, a list of available links could be read to the user, who enters an argument to select a link (e.g., an Internet radio site). In this manner, telephones and other devices without browsers can be used to access content on the Internet.

For example, a virtual environment includes an Internet object. When the object is selected, a connection is made to a site that provides streaming audio. The server system supplies the streaming audio to the teleconferencing system, which mixes the streaming audio on the user's phone line.

Another command could allow a user to give another user or a group of users certain rights or access to one or more of his files or directories. Another command could allow a user to transfer objects (e.g., files, tokens or currency units) to other users. Another command could allow a user to record and leave voice messages for other users (voice messages could be converted to text and left as text messages). Another command could allow a user to present media (such as videos, sound samples and images) to other users (e.g., on a virtual screen), change its representative object (e.g., change the mood of an avatar), initiate or participate in polls or play games.

The teleconferencing system receives and translates the signals and informs the server system to take action (block 240) such as changing the state of an object. The teleconferencing system translates the signals and tells the server system to change the state.

The teleconferencing system can play audio clips, such as sounds in the virtual environment (block 250). The server system can also synchronize the sound clips with state changes of the virtual representation.

The server system can also provide an audio description of the virtual environment (block 250). For example, a virtual environment can be described to a user from the perspective of the user's avatar. Objects that are closer to the user's avatar might be described in greater detail. The description may include or leave out detail to keep the overall length of the description approximately constant. The user can request more detailed descriptions of certain objects, upon which additional details are revealed. The server system can also generate an audio description of options in response to a command (block 250). The teleconferencing system mixes those audio descriptions with the other audio for the user and supplies the mixed sound data to the user's audio-only device (block 260).

The server system can also generate data for controlling audio characteristics over time (block 270). For example, volume of a conversation between two users is a function of distance and/or orientation of their two avatars in the virtual environment. In this example, sound gets louder as the avatars move closer together, and sound gets softer as the avatars move further apart. The server system generates sound coefficients that vary the volume of sound between two users, as a function of the distance between the two users. The coefficients are used by the teleconferencing system to vary sound volume over time (block 280). In this manner, the server system commands the teleconferencing system to attenuate or modify sounds so the conversation is consistent with the virtual environment.

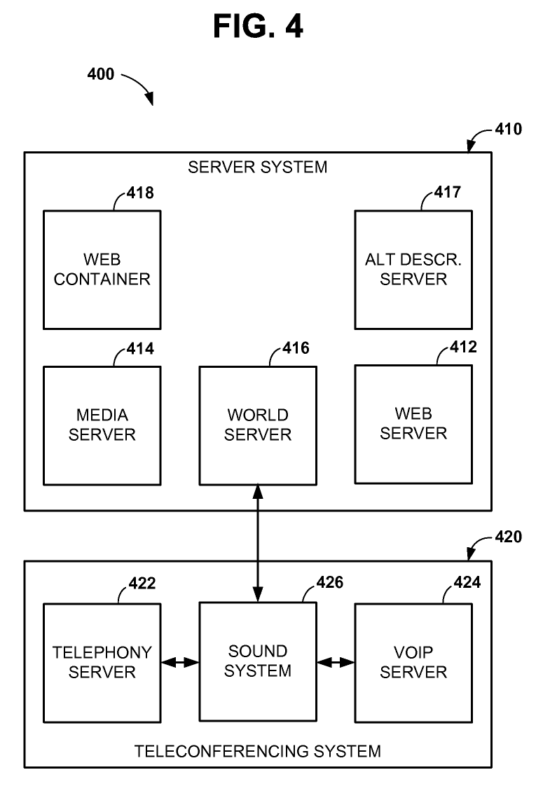

Reference is made to FIG. 4, which illustrates an exemplary web-based communications system 400. The communications system 400 includes a VE server system 410. The “VE” refers to virtual environment.

The VE server system 410 hosts a website, which includes a collection of web pages, images, videos and other digital assets. The VE server system 410 includes a web server 412 for serving web pages, and a media server 414 for storing video, images, and other digital assets.

One or more of the web pages embed client files. Files for a Flash® client, for instance, are made up of several separate Flash® objects (.swf files) that are served by the web server 412 (some of which can be loaded dynamically when they are needed).

A client is not limited to a Flash® client. Other browser-based clients include, without limitation, Java™ applets, Microsoft® Silverlight™ clients, .NET applets, Shockwave® clients, scripts such as JavaScript, etc. A downloadable, installable program could even be used.

Using a web browser, a client device downloads web pages from the web server 412 and then downloads the embedded client files from the web server 412. The client files are loaded into the client device, and the client is started. The client starts running the client files and loads the remaining parts of the client files (if any) from the web server 412.

An entire client or a portion thereof may be provided to a client device. Consider the example of a Flash® client including a Flash® player and one or more Flash® objects The Flash® player is already installed on a client device. When .swf files are sent to and loaded into the Flash® player, the Flash® player causes the client device to display a virtual environment. The client also accepts inputs (e.g., keyboard inputs, mouse inputs) that command the user's representative object to move about and experience the virtual environment.

The server system 410 also includes a world server 416. As used herein, the “world” refers to all virtual representations provided by the server system 410. When a client starts running, it opens a connection with the world server 416. The server system 410 selects a description of a virtual environment and sends the selected description to the client. The selected description contains links to graphics and other media for the virtual environment. The description also contains coordinates and appearances of all objects in the virtual environment. The client loads media (e.g., images) from the media server 414, and projects the images (e.g., in isometric, 3-D).

The client displays objects in the virtual environment. Some of these objects (e.g., avatars) represent users. The animated views of an object could comprise pre-rendered images or just-in-time rendered 3D-Models and textures, that is, objects could be loaded as individual Shockwave® objects, parameterized generic Shockwave® objects, images, movies, 3D-Models optionally including textures, and animations. Users could have unique/personal avatars or share generic avatars.

When a client device wants an object to move to a new location in the virtual environment, its client determines the coordinates of the new location and a desired time to start moving the object, and generates a request. The request is sent to the world server 416.

The world server 416 receives a request and updates the data structure representing the “world.” The world server 416 keeps track of each object state in each virtual environment, and updates the states that change. Examples of states include avatar state, objects they're carrying, user state (account, permissions, rights), and call management. When a user commands an object in a virtual environment to a new state, the world server 416 commands all clients represented in the virtual environment to transition the state of that object, so client devices 120 display the object at roughly the same state at roughly the same time.

The world server 416 can also keep track of objects that transition gradually or abruptly. When a client device commands an object to transition to a new state, the world server 416 receives the command and generates an event that causes all of the clients to show the object at the new state at a specified time.

The communications system 400 also includes a teleconferencing system 420, which allows users represented in a virtual environment to hold teleconferences. Some embodiments of the teleconferencing system 420 may include a telephony server 422 for establishing calls with traditional telephones. For instance, the telephony server 422 may include PBX or ISDN cards for making connections for users who call in with traditional telephones (e.g., touch-tone phones) and digital phones. The telephony server 422 may include mobile network or analog network connectors. The cards act as the terminal side of a PBX or ISDN line and, in cooperation with associated software perform all low-level signaling for establishing phone connections. Events (e.g. ringing, connect, disconnect) and audio data in chunks (of 100 ms, for example) are passed from a card to a sound system 426. The sound system 426, among other things, mixes the audio between users in a teleconference, mixes any external sounds (e.g., the sound of a jukebox, a person walking, etc) and passes the mixed (drain) chunks back to the card and, therefore, to a user.

Some embodiments of the teleconferencing system 420 may transcode calls into VOIP, or receive VOIP streams directly from third parties (e.g., telecommunication companies). In those embodiments, events would originate not from the cards, but transparently from an IP network.

Some embodiments of the teleconferencing system 420 may include a VOIP server 424 for establishing connections with users who call in with VOIP phones. In this case, a client (e.g., the client 160 of FIG. 1) may contain functionality by which it tries to connect to a VOIP soft-phone audio-only device using, for example, an xml-socket connection. If the client detects the VOIP phone, it enables VOIP functionality for the user. The user can then (e.g., by the click of a button) cause the client to establish a connection by issuing a CALL command via the socket to the VOIP phone which calls the VOIP server 424 while including information necessary to authenticate the VOIP connection.

The world server 416 associates each authenticated VOIP connection with a client connection. The world server 416 associates each authenticated PBX connection with a client connection.

The telephony system 422 can also allow users of audio-only devices to control objects in a virtual environment, and move from one virtual environment to another. A user with only an audio-only device can experience sounds of the virtual environment as well as speak with others, but cannot see sights of the virtual environment. The telephony system 422 can use phone signals (e.g., DTMF, voice commands) from phones to control the actions of their corresponding object in the virtual environment.

For devices that are enabled to run Telnet sessions, a user could establish a telnet session to receive information, questions and options, and also to enter commands.

For users that have only audio-only devices, the server system 410 could include means 417 for providing an alternative description of virtual environment. For Telnet-enabled devices, the means 417 could provide a written description of a virtual environment. For other audio-only devices, the means 417 could include a speech synthesis system for providing a spoken description, which is heard on the audio-only device.

The sound system 426 can mix sounds of the virtual environment with audio from the teleconferencing. Sound mixing is not limited to any particular approach. Approaches are described below.

The VE server system 410 may also include one or more servers that offer additional services. For example, a web container 418 might be used to implement servlet and JavaServer Pages (JSP) specifications to provide an environment for Java code to run in cooperation with the web server 412.

All servers in the communications system 400 can be run on the same machine, or distributed over different machines. Communication may be performed by a remote invocation call. For example, an HTTP or HTTPS-based protocol (e.g. SOAP) can be used by the server and network-connected devices to transport the clients and communicate with the clients.

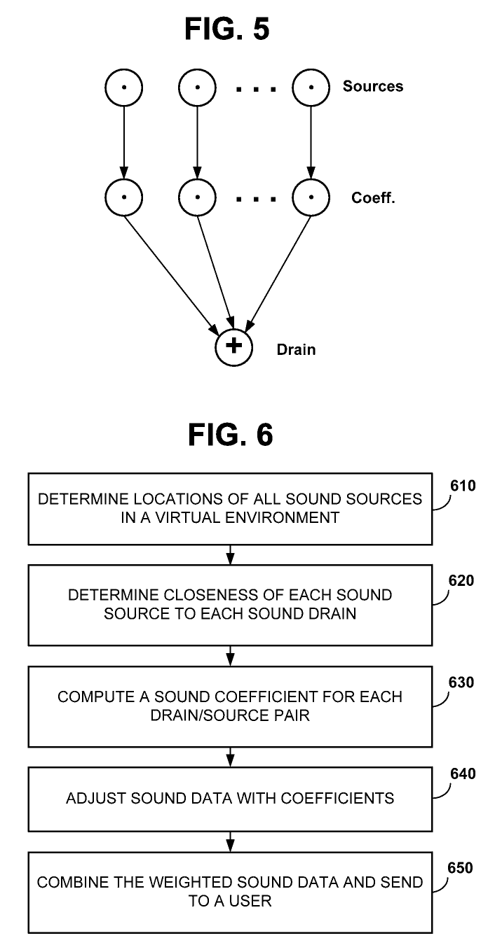

Reference is made to FIGS. 5 and 6, which illustrate a first approach for mixing sound. The world server 416 generates sound coefficients, which the sound system 426 uses to vary the audio characteristics (e.g., audio volume) of sound data that goes from sound sources to sound drains. A sound drain refers to the representative object of a user who can hear sounds in the virtual environment. A sound coefficient can vary the audio volume or other audio characteristics as a function of closeness of a source and a drain.

At block 610, locations of all sounds sources in a virtual environment are determined. Sound sources include objects in a virtual environment (e.g., a jukebox, speakers, a running stream of water). Sound sources also include the representative objects of those users who are talking. A sound source could be multimedia from an Internet connection (e.g., audio from a YouTube video).

The following functions are performed for each drain in the virtual environment. At block 620, closeness of each sound source to a drain is determined. This function is performed for each sound drain in the virtual environment. The closeness is not limited to distance. The world server 416 can perform this function, since it maintains the information about location of the sound sources.

At block 630, a coefficient for each drain/source pair is computed. Each coefficient varies the volume of sound from a source as a function of its closeness to the drain. This function may also be performed by the world server 416, since it maintains information about locations of the objects. The world server 416 supplies the sound coefficients to the sound system 426.

The sound from a source to a drain can be cut off (that is, not heard) if the source is outside of an audio range of the drain. The coefficient would reflect such cut-off (e.g., by being set to zero or close to zero). The world server 416 can determine the range, and whether cut-off occurs, since it keeps track of the object states.

At block 640, sound data from each sound source is adjusted with its corresponding coefficient. As a result, the sound data from the sound sources are weighted as a function of closeness to a drain.

At block 650, the weighted sound data is combined and sent back on a phone line or VOIP channel to a user. The sound system 426 may include a processor that receives a list of patches, sets of coefficients, and goes through the list. The processor can also use heuristics to determine whether it has enough time to patch all connections. If not enough time is available, packets are dropped.

In addition to or instead of sound mixing illustrated in FIGS. 5 and 6, to preserve computing power and decrease latencies, the teleconferencing system 420 could switch together source/drain pairs to direct connections. This might be done if the world server 416 determines that two users can essentially only hear each other. The teleconferencing system 420 could also premix some or all sources for several drains whose coefficients are similar. In the latter case each user's own source may have to be subtracted from the joined drain to yield his drain.

1. A communications system comprising:
a server system for providing a virtual representation including at least one object; and
a teleconferencing system for establishing audio communications with an audio-only device;
an object in the virtual representation controlled in response to signals from the audio-only device.

2. The communications system of claim 1, wherein at least one of the objects is movable and represents a user of an audio-only device.

3. The communications system of claim 2, wherein an object representing a user of an audio-only device is an avatar; and wherein signals from the audio-only device cause the avatar to move about the virtual representation.

4. The communications system of claim 2, wherein signals from the audio-only device cause the object to move about the virtual representation;
and wherein the teleconferencing system allows a user of the audio-only device to speak with other users represented in the virtual representation, but not see the virtual representation.

5. The communications system of claim 1, wherein the server system provides additional virtual representations, and wherein a signal from the audio-only device causes an object representing the user of an audio-only device to go to a different virtual representation.

6. The communications system of claim 1, wherein an object representing a user of an audio-only device can be assigned to the virtual representation by dialing directly to that virtual representation.

7. The communications system of claim 1, wherein the virtual representation is a virtual environment, and wherein signals from the audio-only device allow a user to interact with the virtual environment.

8. The communications system of claim 1, wherein the audio-only device is a phone, and wherein the signals are phone signals.

9. The communications system of claim 1, wherein the signals are dial tone (DTMF) signals.

10. The communications system of claim 1, wherein the signals are voice commands.

11. The communications system of claim 1, further comprising means for providing an audio description of the virtual representation to the audio-only device.

12. The communications system of claim 11, wherein objects that are closer to a user's representative object in the virtual representation are described in greater detail.

13. The communications system of claim 11, wherein the virtual representation is described from a first person perspective.

14. The communications system of claim 1, wherein a first object in the virtual representation represents an Internet resource; and wherein a user of an audio-only device can access the Internet by controlling the state of the first object.

15. The communications system of claim 1, wherein the teleconferencing system includes a VOIP system for establishing VOIP connections with network-connected devices.

16. The communications system of claim 1, wherein the user of the audio-only device is represented in the virtual representation for others to see;
and wherein the user's representative object indicates audio-only capability.

17. A system comprising:
means for providing a virtual representation including objects;
means for receiving signals from audio-only devices; and
means for controlling states of the objects in response to the signals.

18. A communications system for providing a virtual environment including a plurality of objects, the objects having changeable states; and for establishing audio communications with audio-only devices; the system controlling the states of the objects in the virtual representation in response to signals from the audio-only devices, such that users of the audio devices can interact with the virtual environment.

19. A method of controlling objects in a virtual environment comprising:
receiving signals from audio-only devices; and
controlling states of the objects in response to the signals.

20. The method of claim 19, further comprising providing an audio description of the virtual environment to the audio-only device.
